(19) United States
(12) Patent Application Publication
(10) Pub. No.: US 2006/0016761 A1
(43) Pub. Date: Jan. 26, 2006

(54) Dewatering of suspensions

(76) Inventors: Amjad Mohmood Mohammed, Bradford (GB); Steven Weir, Bradley (GB); Bryan David Grey, Bradford (GB)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/526,176

(22) PCT Filed: Aug. 25, 2003
(86) PCT No.: PCT/EP03/09381

§ 371 Date: Mar. 1, 2005

(30) Foreign Application Priority Data
Sep. 5, 2002 (GB) 0220714.0

(51) Int. Cl. C02F 1/52

(52) U.S. Cl. 210/728

(57) ABSTRACT

A method of dewatering suspensions in which a high molecular weight, water soluble, cationic polymer flocculant and an encapsulated low molecular weight water soluble, coagulant are mixed with the suspension. The coagulant is not released into the suspension until after flocculation has taken place.

This invention relates to dewatering of suspensions and more particularly dewatering of suspensions using encapsulated material blended with a flocculant.

In the dewatering of suspensions it is known to add a high molecular weight, water soluble polymer as a flocculent to the suspension in order to remove the liquid from the suspension and greatly increase the dry solids of the suspension. It has now been found that the addition of a coagulant will greatly improve the dryness of the separated solids. However if coagulant is added to the suspension before flocculation or immediately afterwards there is no increase in dryness. On the contrary the addition of coagulant before flocculation can actually lead to a decrease in dryness. In order to obtain the benefit of increased dryness therefore it has been necessary to add the coagulant after flocculation has been substantially completed and partial dewatering has taken place. In other words the addition of coagulant has to be made to the thickened suspension which requires additional equipment to handle the coagulant and for mixing it into the thickened suspension.

At the same time care must be taken to control loss of coagulant during filtration of the suspension. Because the coagulant tends to act relatively slowly when compared with the flocculent, if it is not to be lost through the filter the suspension may have to be withheld from filtration for a sufficient time to allow further treatment to proceed.

All these factors have an adverse effect on the economics of the dewatering process.

The invention has been made with a view to dealing with this problem.

According to the invention there is provided a method for dewatering suspensions comprising adding to the suspension a high intrinsic viscosity (IV), water soluble, cationic polymer flocculent and a coagulant, the coagulant being encapsulated or entrapped whereby release of the coagulant into the suspension is delayed.

With the invention, therefore, flocculation proceeds rapidly following addition of the high IV polymer flocculent to the suspension and is initially unaffected by the encapsulated or otherwise entrapped coagulant present also in the suspension but not having any effect. After free drainage of the suspension the coagulant is released into the suspension for example by rupturing of the capsules which enclose the coagulant or by migration from a matrix in which the coagulant is entrapped. Thus no additional equipment is required for mixing the coagulant into the suspension at a later stage than the flocculant since it can be added at the same time as the flocculant. Moreover by choosing the appropriate encapsulation or other form of entrapment the coagulant is released into the suspension when flocculation and free drainage is substantially completed and any delay before the final dewatering stage can be kept to a minimum or eliminated completely.

In another aspect of the invention there is provided a composition for use in dewatering suspensions comprising a high IV, water soluble, cationic polymer flocculant and a coagulant, the coagulant being encapsulated or otherwise entrapped.

The coagulant may be any of the materials known for use as coagulants particularly low IV water soluble, cationic polymers and generally having an IV below 1.5 dl/g (measured using a suspended level viscometer on solutions of the coagulant polymer alone in 1 molar sodium chloride buffered to pH 7.5 at 25° and inorganic materials such as polyaluminium chloride.

The cationic coagulant may comprise a polyamine coagulant polymer, such as a polymer made by condensation of an amine and/or a diamine or higher amine (e.g. ethylene diamine or tetraethylene pentamine) with epichlorohydrin or other epihalohydrin or with dichloroethane or other dihaloalkane. Other suitable coagulants include polyethyleneimine, homopolymers of water soluble ethylenically unsaturated cationic monomer or a blend of one or more cationic ethylenically unsaturated monomers with one or more other ethylenically unsaturated monomers. The blend may be formed with acrylamide or other water soluble ethylenically unsaturated non-ionic monomer. The cationic monmer can be a diallyl quaternary monmer, generally diallyl dimethyl ammonium chloride (DADMAC) or dialkylaminoalkyl (meth)-acrylate or acrylamide wherein the alkyl groups generally contain 1 to 4 carbon atoms. Examples are dimethyl or diethyl aminoethyl or propyl (meth)-acrylate or acrylamide or dimethyl or diethyl aminomethyl (meth)-acrylamide. The monomer may be introduced as an acid addition salt or the polymer can be converted into such a salt after polymerisation. The quaternising group is usually methyl chloride or other aliphatic quaternising group. An acid such as adipic acid may advantageously be present when the coagulant is released into the thickened suspension. A preferred way of achieving this is to add encapsulated acid to the suspension at a suitable stage in the dewatering treatment, for example prior to flocculation.

Encapsulation of the coagulant may be effected by known techniques utilising melamine/formaldehyde resin such as described for example in WO-A-98/28975 Encapsulation using a polyamide can also be adopted, an example of such encapsulation being described in U.S. Pat. No. 6,225,372.

The flocculant material preferably has an IV above 2.0 dl/g and desirably well above that, for example above 4.0 dl/g. The flocculant can be any of the polymers discussed above for the low IV polymer particularly preferred being a mixture of 80% dimethylaminoethylacrylate methyl chloride quaternary and 20% acrylamide with an IV of 8.0 dl/g.

The coagulant in encapsulated form or otherwise entrapped and the flocculant may be added to the suspension together or separately. Preferably the flocculant and coagulant are premixed and then added to the suspension as a homogeneous blend. If desired a wetting agent can be added to the mixture followed by ageing to improve homogeneity. The ratio of coagulant to flocculant is preferably selected from the range 0.2:1.0 to 2.0:1.0 by weight, the selection being made having regard to the suspension to be dewatered. Preferably a concentrated mixture of flocculant and coagulant is prepared which is diluted appropriately before addition to a suspension. The encapsulated or otherwise entrapped coagulant can be one coagulant type or a mixture of two or more coagulants.

After addition to the suspension the flocculent and encapsulated or otherwise entrapped coagulant are mixed with the suspension so that they are distributed throughout the suspension, preferably as evenly as possible.

In the dewatering process the flocculated suspension is initially drained—so called ‘free drainage’. At this stage in the method of the invention the encapsulated or otherwise entrapped coagulant is preferably not released into the suspension and takes no part in the dewatering. Following free drainage, the thickened substrate is subjected to pressure dewatering whereby a solid cake is produced. During this pressure filtration it would seem that the coagulant capsules become ruptured or the entrapment broken down so that the coagulant diffuses into the thickened suspension. This leads to an improvement in the dryness of the cake compared to the conventional dewatering methods.

The invention is applicable to dewatering of suspensions generally, some examples of which are described in WO 02/12213. Thus the invention can be used for dewatering aqueous suspensions or mixtures of organic and inorganic materials or suspensions made entirely of organic material. Examples of such aqueous suspensions include industrial waste from dairies, canneries, chemical manufacturing waste, distillery waste, fermentation waste, waste from paper manufacturing plants, waste from dyeing plants, sewage suspensions such as any type of sludge derived from a sewage treatment plant including digested sludge, activated sludge, raw or primary sludge or mixtures thereof. In addition to the organic material present the aqueous suspensions may also contain detergents and polymeric materials which can hinder precipitation. Modified methods for treatment in view of these factors are known to those familiar with the art.

The dosage of flocculant and encapsulated or otherwise entrapped coagulant will depend upon the content of the suspension. Optimum results require accurate dosing. If the dose is too low or too high flocculation may be inferior. In addition the degree of agitation of the suspension during flocculation can also affect performance. The flocs are very sensitive to agitation especially if the dosage is not at an optimum when there is a possibility that solids will be redispersed as discrete solids.

The invention can also be used to aid retention and/or drainage in the production of paper in which the suspensions to be treated contain cellulosic fibres and optional fillers. (“Paper” as used herein includes not only paper but also other cellulosic fibre-containing sheet or web-like products such as board and paperboard). In such a process the flocculated suspension is dewatered on a wire to form a wet web containing cellulosic fibres, whereafter the encapsulated or otherwise entrapped coagulant is released into the wet web. Improved drainage and/or retention can be obtained with papermaking stocks having high contents of salt and thus having high conductivity levels, and colloidal materials.

The invention makes it possible to increase the speed of the paper machine and to use lower dosages of additives to give a corresponding drainage and/or retention effect thereby leading to an improved papermaking process and economic benefits.

The invention can also be applied to papermaking processes using wood-containing fibre stocks and so called dirty or difficult stocks, for example those prepared from certain grades of recycled fibres and/or processes with extensive white water recirculation and limited fresh water supply and/or processes using fresh water having high salt contents, in particular salts of di- and multivalent cations such as calcium.

The dosages of flocculent and encapsulated or otherwise entrapped coagulant to be added to the stock can vary within wide limits depending on, inter alia type of stock, salt content, type of salt or salts, filler content, type of filler etc.

The stock to be treated can contain additives such as anionic microparticulate materials, for example anionic organic particles and anionic inorganic particles, water soluble anionic-vinyl addition polymers, low molecular weight cationic organic polymers, aluminium compounds and combinations thereof.

The following Examples further illustrate the invention reference being made also to the accompanying drawings in which:

FIG. 1 is a graph showing the effect of the invention on free drainage;

FIG. 2 is a graph showing the effect of the invention on the cake solids;

FIGS. 3 and 4 are repeats of the procedures shown in FIGS. 1 and 2 respectively as a check on the results;

FIGS. 5 and 6 are graphs showing the effect on free drainage and cake solids respectively with a different coagulant;

FIGS. 7 and 8 are graphs showing the effect on free drainage and cake solids respectively when polyamide capsules are used; and

FIG. 9 is a graph showing the effect of including acid capsules.

In the Examples all ratios and percentages are by weight. In the Figures the x axis indicates the dose of flocculant.

### EXAMPLE 1

Homogeneous mixtures of melamine/formaldehyde encapsulated commercially available coagulant “Magnafloc” (Trade Mark) 1697 (poly DADMAC IV>1.0) and commercially available flocculant “Zetag” (Trade Mark) 7587 were prepared at ratios of capsules to flocculant of 0.25:1, 0.5:1 and 1:1. These were diluted with water to a 1% active solution based on the flocculant. Corresponding mixtures were also made up at the same ratios but without any coagulant material in the capsules. A control solution was also made up with no capsules.

200 ml aliquots of DP/A, municipal sewage sludge were treated using different dosages of the above solutions. In each case the substrate and solution were thoroughly mixed to bring about flocculation. The flocculent was poured through a filter and the filtrate collected in a measuring cylinder. The volume was measured after 5 seconds free drainage time. The results are shown in FIG. 1. As can be seen the presence of capsules with and without active material made substantially no difference to the free drainage.

The thickened substrate collected in the filter was transferred to a piston head pressure cylinder with a filter-clothed head on one side. Pressure was applied to remove more water. The pressure was applied at 10 psi (0.69 bar) and increased to 100 psi (6.9 bar) over 10 minutes. The cake solids were removed, weighed and then placed in an oven overnight at 110° C. After reweighing the dry solids of the cake was calculated. The results are shown in FIG. 2. This shows an increase in dryness. The average increase of dosages at 150 and 200 ppm in dryness with solutions containing 0.25:1 and 0.5:1 capsules (containing active material) to flocculant was about 16%.

It should be noted that the cake solids figure of about 22% for the 50% blank at a dosage of 150 ppm shown in FIG. 2 was obtained from a laboratory test and is therefore higher than the amount that would be expected in practice—probably a cake solids amount of about 19 to 20%.

### EXAMPLE 2

The procedure of Example 1 was repeated but with only three solutions containing capsules and flocculant in the ratio 1:0.25 as follows:
2699—Capsules with no active material
2361—The same as in Example 1
2363—Double the activity of 2361

The results after free drainage for 5 seconds are shown in FIG. 3. There is no significant difference from the results obtained in Example 1.

An increase in cake dryness of about 11% can be seen in respect of 2361 in FIG. 4.

2363 showed no improvement in dryness. However it was later discovered that the capsule walls had not formed properly so that the coagulant was released at the wrong time.

### EXAMPLE 3

The same procedure was followed as in Example 1 but using as coagulant, in the capsules, poly aluminium chloride in three solutions at ratios of 0.3:1, 0.6:1 and 0.9:1, capsules to flocculant.

The free drainage results, which show no difference, are shown in FIG. 5.

The effect on cake solids is shown in FIG. 6 and indicates an increase in dryness of about 16%.

### EXAMPLE 4

The same procedure was followed as in Example 1 except that the capsules were of polyamide. Two solutions were used having ratios of capsules to flocculant of 1:1 and 2:1, these higher ratios than before being chosen because the capsules were supplied as an emulsion.

The free drainage results are shown in FIG. 7 and show no difference

The cake solids results are shown in FIG. 8 and show an increase in dryness of about 10%.

### EXAMPLE 5

The same procedure was followed as in Example 1 except that capsules of citric acid were blended with the flocculant in the ratio 1:1 by weight. The effect on the cake solids is shown in FIG. 9 indicating an improvement in dryness compared to the use of flocculant without acid.

The above Examples demonstrate clearly the benefit in improved dryness provided by the invention. In the field of dewatering of suspensions these increases are economically highly significant and lead to considerable energy savings.

1. A method for dewatering suspensions comprising adding to the suspension a composition comprising -high IV, water soluble, cationic polymer flocculent and a coagulant, the coagulant being encapsulated or otherwise entrapped whereby release of the coagulant into the suspension is delayed.

2. A method as claimed in claim 1, wherein the coagulant is selected from low IV, water soluble, cationic polymers and inorganic coagulants.

3. A method as claimed in claim 2, wherein the water soluble, cationic polymer coagulant has an IV below 1.5 dl/g.

4. A method as claimed in claim 1, wherein the flocculant has an IV above 2.0 dl/g.

5. A method as claimed in claim 1, wherein the flocculant and encapsulated or otherwise entrapped coagulant are added to the suspension together or separately.

6. A method as claimed in claim 5, wherein the flocculant and encapsulated or otherwise entrapped coagulant are added to the suspension together in the form of an homogeneous blend.

7. A method as claimed in claim 6, wherein the blend includes a wetting agent.

8. A method as claimed in claim 1, wherein an acid is present when the coagulant is released into the suspension.

9. A method as claimed in claim 1 wherein the suspension containing the flocculant and encapsulated or otherwise entrapped coagulant is subjected to drainage and the coagulant is released from encapsulation or other entrapment after the drainage of the suspension.

10. A method as claimed in claim 9, wherein the thickened suspension obtained from free drainage is subjected to filtration under pressure and the coagulant is released from encapsulation or other entrapment during the filtration under pressure.

11. A composition for dewatering suspensions as claimed in claim 1.

12. A composition as claimed in claim 11, wherein the coagulant is selected from low IV, water soluble, cationic polymers and inorganic coagulants.

13. A composition as claimed in claim 12, wherein the water soluble, cationic polymer coagulant has an IV below 1.5 dug.

14. A composition as claimed in claim 11, wherein the flocculant has an IV above 2.0 dl/g.

15. A composition as claimed in claim 11, wherein the flocculant and coagulant are combined together as an homogeneous blend.

16. A composition as claimed in claim 15, wherein the blend includes a wetting agent.

17. A composition as claimed in claim 11 including an acid.

18. A composition as claimed in claim 17, wherein the acid is encapsulated.

19. A composition as claimed in claim 11, wherein the ratio of coagulant to flocculant is in the range of from 0.2:1.0 to 2.0:1.0 by weight.

20. A method as claimed in claim 2, wherein the inorganic coagulant is polyaluminum chloride.
